(19) United States
(12) Patent Application Publication
(10) Pub. No.: US 2026/0145509 A1
(43) Pub. Date: May 28, 2026

(54) TWIN MOTOR SYSTEM FOR AN ELECTRIC VEHICLE

(71) Applicants: HYUNDAI MOTOR COMPANY, Seoul (KR); KIA CORPORATION, Seoul (KR)

(72) Inventors: Hong Seok Yang, Hwaseong-si (KR); Sungik Bae, Hwaseong-si (KR); Yongsung Jang, Hwaseong-si (KR)

(73) Assignees: HYUNDAI MOTOR COMPANY, Seoul (KR); KIA CORPORATION, Seoul (KR)

(21) Appl. No.: 19/343,750

(22) Filed: Sep. 29, 2025

(30) Foreign Application Priority Data
Nov. 28, 2024 (KR) 10-2024-0173130

(51) Int. Cl. B60K 11/02; B60K 1/02

(52) U.S. Cl. CPC B60K 11/02; B60K 1/02

(57) ABSTRACT

A twin motor system for an electric vehicle includes: a first motor housing accommodating a first motor having a first stator and a first rotor therein, and in which a first oil path is formed to supply cooling oil, which is supplied from an oil pump, to an outer end coil portion and a bearing part of the first motor; a second motor housing disposed in parallel adjacent to the first motor housing, accommodating a second motor having a second stator and a second rotor therein, and in which a second oil path is formed to supply the cooling oil to an outer end coil portion and a second outer bearing part of the second motor; a motor cover disposed between the first motor housing and the second motor housing, in which a third oil path and a fourth oil path are formed to supply the cooling oil.

### CROSS-REFERENCE TO RELATED APPLICATION

This application claims priority to and the benefit of Korean Patent Application No. 10-2024-0173130 filed with the Korean Intellectual Property Office on Nov. 28, 2024, the entire contents of which are incorporated herein by reference.

### FIELD

The present disclosure relates to a twin motor system for electric vehicles,

and more particularly, to a twin motor system for electric vehicles including an effective cooling structure.

### BACKGROUND

Eco-friendly technology in the automobile field is a core technology essential for the survival of the future automobile industry, and automobile manufacturers are making every effort to develop eco-friendly automobiles in order to achieve environmental and fuel efficiency (electric efficiency) regulations.

As part of environmentally friendly automobiles, automobile manufacturers are focusing on the development of environmentally friendly electric vehicles, including hybrid electric vehicles (HEV), plug-in hybrid electric vehicles (PHEV), battery electric vehicles (BEV), and fuel cell electric vehicles (FCEV).

Such eco-friendly vehicles may use a motor as a power source to provide rotational power, and increase torque through a reducer to provide driving force to the vehicle, thereby contributing to the improvement of air pollution caused by conventional pure internal combustion engine vehicles.

Eco-friendly vehicles have various technical constraints such as weight and cost, so automobile manufacturers are paying attention to electric vehicles as a practical alternative to satisfy exhaust emission regulations and improve fuel efficiency performance, and are also conducting intense competition in the research and development of power transmission systems for their commercialization.

Unlike internal combustion engine automobiles, electric vehicles use a motor having constant torque as a power source. However, a large amount of heat may be generated due to power loss caused by copper loss occurring in a conduction part due to resistance of a coil or conductor of the motor, and iron loss generated in a core part by magnetization of a core.

In other words, in a motor, Joule heat is generated by internal losses such as copper loss and iron loss, and a portion of the generated heat is accumulated inside to increase the internal temperature of the motor, while the remainder is transferred, ultimately resulting in thermal equilibrium. However, since the components constituting the motor have prescribed allowable heat resistance grades, temperature management is desired.

In particular, in the case of a twin motor system including two motors, cooling of the winding portion and end coil portion of the rotor, stator, or the like having the highest temperature is important for the performance of each motor, and thus a solution for addressing this issue may be required.

The matters stated in this background art section have been written to enhance the understanding of the background of the present disclosure, and may include matters that are not prior art already known to those of ordinary skill in the art to which this technology pertains.

### SUMMARY

The present disclosure provides a twin motor system for an electric vehicle which includes a first and a second motor positioned in parallel, and compacts the driving mechanism by sharing a single motor cover between a first motor housing and a second motor housing that respectively accommodate the first motor and the second motor.

The present disclosure may provide a twin motor system for an electric vehicle, in which first and second motors are arranged in parallel, and a compact driving mechanism is achieved by sharing a single motor cover between a first motor housing and a second motor housing, which respectively accommodate the first and second motors, while allowing cooling via a flow path formed within the first and second motor housings and the motor cover.

The present disclosure may provide a twin motor system for electric vehicles, which may directly supply cooling oil to heat generating portions such as each winding portion and each end coil portion of the first and second motors, thereby enabling effective cooling.

According to at least one embodiment of the present disclosure, a twin motor system for an electric vehicle may include a first motor housing accommodating a first motor having a first stator and a first rotor therein, and a first oil path is formed in the first motor housing to supply cooling oil, which is supplied from an oil pump, to an outer end coil portion and a bearing part of the first motor. The twin motor system further includes a second motor housing disposed in parallel adjacent to the first motor housing and accommodating a second motor having a second stator and a second rotor therein, and a second oil path is formed in the second motor housing to supply the cooling oil to an outer end coil portion and a second outer bearing part of the second motor. The twin motor system further includes a motor cover including a third oil path and a fourth oil path and disposed between the first motor housing and the second motor housing to protect inner sides of each of the first motor and the second motor. In particular, the third oil path is configured to supply the cooling oil, from a first side, to an inner end coil portion, the first stator, the first rotor, and a first inner bearing part of the first motor and a second inner bearing part of the second motor. The fourth oil path is configured to supply the cooling oil, from a second side, to an inner end coil portion, the second stator, and the second rotor of the second motor. The twin motor system further includes first and second reducers respectively disposed on outer sides of the first motor housing and the second motor housing.

The twin motor system may further include a first outer bearing part mounted to the first motor housing and rotatably supporting an outer end of a first motor shaft on which the first rotor is installed.

The first oil path may include: a first supply passage formed in a radial direction inside an outer surface from one side of the first motor housing to the first outer bearing part, and supplying cooling oil; a first branch flow channel branching from the first supply passage toward an outer surface of the first rotor; and a first branch pipe installed on the first branch flow channel and guiding the cooling oil to the outer end coil portion of the first motor.

The twin motor system may further include a second outer bearing part mounted to the second motor housing and rotatably supporting an outer end portion of a second motor shaft on which the second rotor is installed.

The second oil path may include: a second supply flow path formed in a radial direction inside an outer surface from one side of the second motor housing to the second outer bearing part and supplying cooling oil; a second branch flow path branched from the second supply flow path toward an outer surface of the second rotor; and a second branch pipe provided on the second branch flow path and inducing the cooling oil to the outer end coil portion of the second motor.

The motor cover may include first and second supply ends formed axially on opposite central sides thereof to supply the cooling oil toward an interior of a first motor shaft of the first motor and an interior of a second motor shaft of the second motor. The twin motor system may further include first and second inner bearing parts configured to rotatably support an inner end of the first motor shaft and an inner end of the second motor shaft, respectively, and mounted between both sides of the motor cover and the inner ends of the first and second motor shafts.

The third oil path may include: a third supply passage formed radially inside from one side of the motor cover to a first supply end to supply the cooling oil; a third branch hole branched from the third supply passage toward an inner surface of the first stator; a third branch pipe installed on the third branch hole to guide the cooling oil to the inner end coil portion of the first motor; and a third branch passage branched from the third supply passage to both sides toward the first and second inner bearing parts.

The fourth oil path may include: a fourth supply passage formed radially inside from a second side of the motor cover to a second supply end to supply the cooling oil; a fourth branch hole branched from the fourth supply passage toward the inner side surface of the second stator; and a fourth branch pipe installed on the fourth branch hole to guide the cooling oil to the inner end coil portion of the second motor.

The oil pump may be an electronic oil pump connected through the first, second, third, and fourth oil paths and an oil supply line.

The twin motor system for an electric vehicle according to an embodiment disclosed in the present disclosure has an effect of being able to compactly configure a drive mechanism constituted as a twin motor by arranging the first motor and the second motor in parallel, and by sharing the single motor cover between the first motor housing and the second motor housing that respectively accommodate the first and second motors.

In addition, the twin motor system for an electric vehicle according to the disclosed embodiment of the present disclosure has the effect of enabling effective cooling by directly supplying cooling oil to heat generating portions such as each winding portion and each end coil portion of the first and second motors, and the bearing part, through the flow path including four oil paths formed inside the first and second motor housings and the motor cover.

In addition, effects that may be obtained or predicted by the embodiments of the present disclosure will be directly or implicitly disclosed in the detailed description of the embodiments of the present disclosure. That is, various effects expected according to the embodiments of the present disclosure will be disclosed in the detailed description to be described later.

### BRIEF DESCRIPTION OF THE DRAWINGS

These drawings are referred to for explaining some embodiments of the present disclosure, and therefore, the technical spirit of the present disclosure should not be construed as being limited only to the drawings attached.

FIG. 1 is a cross-sectional view of a twin motor system for an electric vehicle according to an embodiment of the present disclosure.

FIG. 2 is an enlarged view of the “A” portion of FIG. 1.

FIG. 3 is a diagram showing an oil path applied to a twin motor system for an electric vehicle according to an embodiment of the present disclosure.

FIG. 4 is an enlarged view of the “B” portion of FIG. 3.

FIG. 5 is an enlarged view of the “C” portion of FIG. 3.

FIG. 6 is an enlarged view of the “D” portion of FIG. 3.

The drawings referenced above are not necessarily depicted to scale, and should be understood as providing a somewhat simplified illustration of various features of the present disclosure. For example, certain design features of the present disclosure including specific dimensions, directions, positions, and shapes may be partially determined by particular intended applications and use environments.

### DETAILED DESCRIPTION

Hereinafter, embodiments disclosed in the present disclosure are described in detail with reference to the accompanying drawings. Identical or similar components are assigned identical or similar reference numerals, and redundant description thereof has been omitted.

In describing the embodiments disclosed in the present specification, if it is determined that detailed descriptions of related known techniques may obscure the gist of the embodiments disclosed in the present specification, their detailed descriptions are omitted. In addition, the accompanying drawings are provided only to facilitate easy understanding of the embodiments disclosed in this specification, and the technical concept disclosed in this specification is not limited by the accompanying drawings. It should be understood that all modifications, equivalents, and substitutes included within the spirit and scope of the present invention are included.

Terms including ordinals such as first, second, and the like may be used to describe various components, but the components are not limited by the terms. The above terms are used only for the purpose of distinguishing one component from another component. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

When a certain component is referred to as being “connected” or “coupled” to another component, it should be understood that it may be directly connected or directly coupled to the other component, but that another component may also be present in between.

On the other hand, when it is stated that a certain component is “directly connected” to another component or “directly coupled” to another component, it should be understood that no other components are present therebetween.

In this application, terms such as “including” or “having” are intended to specify that features, numbers, steps, operations, components, parts, or combinations thereof as described in the specification exist, and are not to be construed as precluding the possibility that one or more other features, numbers, steps, operations, components, parts, or combinations thereof exist or may be additionally included.

The terms such as “˜unit”, “˜part”, “˜device”, “˜module”, and “˜means” described in the specification are assigned or used interchangeably solely for the convenience of preparing the specification and do not have distinct meanings or roles by themselves. In addition, the terms such as “˜unit”, “˜part”, “˜device”, “˜module”, and “˜means” described in the specification may refer to a unit that processes at least one function or operation, and may be implemented by hardware, software, or a combination of hardware and software.

As used herein, singular forms are intended to include plural forms as well, unless the context clearly indicates otherwise. As used herein, the term “and/or” includes any one or all combinations of the associated listed items.

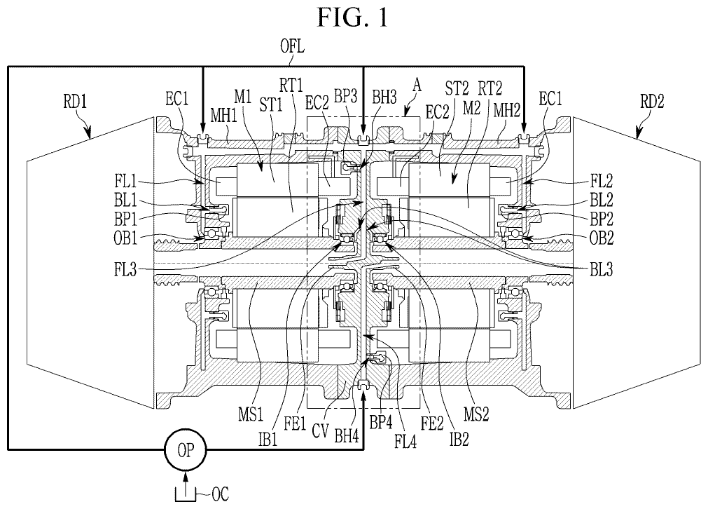

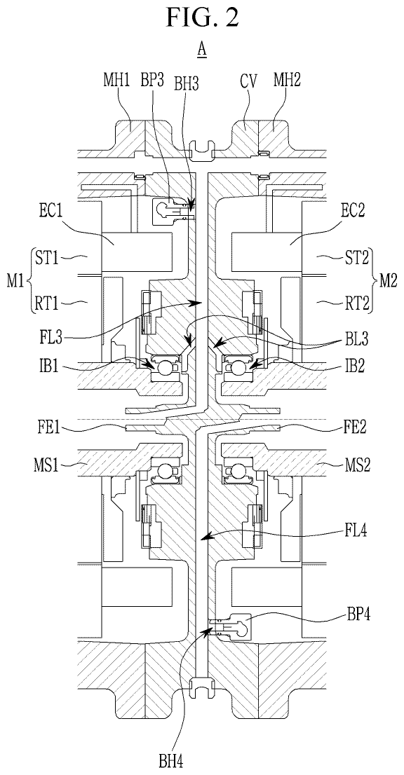

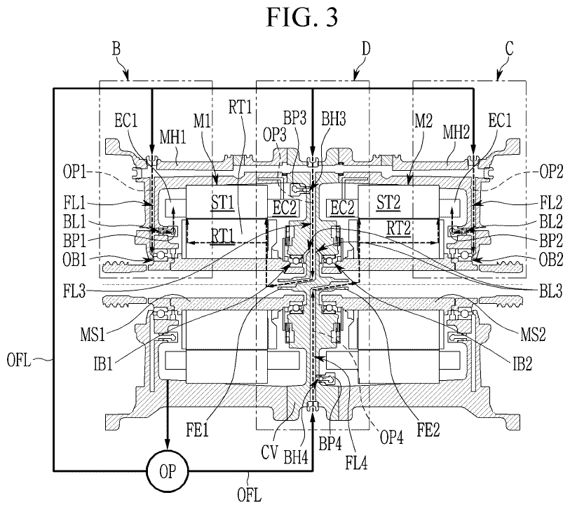

FIG. 1 is a cross-sectional view of a twin motor system for an electric vehicle according to an embodiment of the present disclosure, FIG. 2 is an enlarged view of the “A” portion of FIG. 1, and FIG. 3 is a diagram illustrating an oil path applied to a twin motor system for an electric vehicle according to an embodiment of the present disclosure.

Referring to FIG. 1, the twin motor system for an electric vehicle (hereinafter, referred to as a twin motor system), according to the embodiment, uses a twin motor, in which a first motor M1 and a second motor M2 are positioned parallel to each other in a left-right symmetrical manner, as a power source.

A first reducer RD1 is installed on the outer side of the first motor M1, and a second reducer RD2 is installed on the outer side of the second motor M2, and may be connected to reduce rotation speed and transmit the rotational power to the left and right wheels.

As described above, the twin motor system including the first and second motors (M1, M2) and the first and second reducers (RD1, RD2) may be installed at the front or rear of a vehicle to implement an electric vehicle having front-wheel drive or rear-wheel drive.

The first motor M1 includes a first stator ST1 and a first rotor RT1, and the first stator ST1 may include an outer end coil portion EC1 and an inner end coil portion EC2 at both sides.

Further, the second motor M2 may include a second stator ST2 and a second rotor RT2, and the second stator ST2 may include an outer end coil portion EC1 and an inner end coil portion EC2 at both sides.

In general, the first and second stators (ST1, ST2) are installed having coils wound thereon, and may exhibit various electrical characteristics according to the winding method of the coils. In particular, due to their wound form, distributed windings and hairpin windings form an outer end coil portion EC1 and an inner end coil portion EC2 on both axial directions of the stator core, and when the coil is energized, heat is generated due to copper loss, requiring a cooling process.

In addition, each rotational shaft of the first and second motors (M1, M2), i.e., first and second motor shafts MS1 and MS2, is formed as a hollow shaft, and oil for lubrication or cooling may be supplied to the interior of the first and second motor shafts.

As described above, the twin motor system utilizing the first motor M1 and the second motor M2 has technical features in a first motor housing MH1, a second motor housing MH2, and a motor cover CV, and includes the first reducer RD1 and the second reducer RD2.

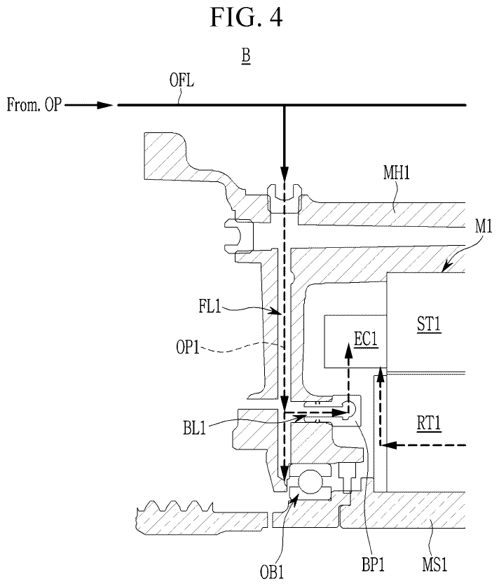

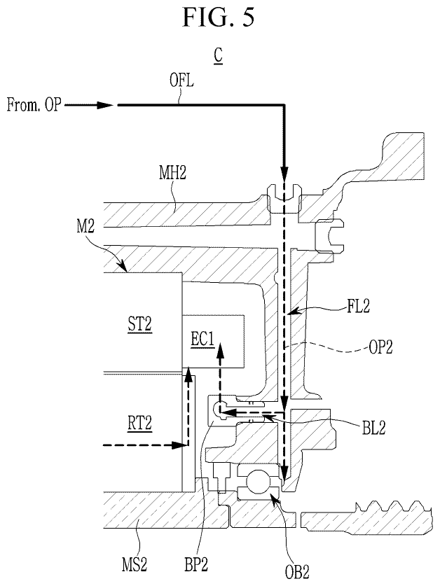

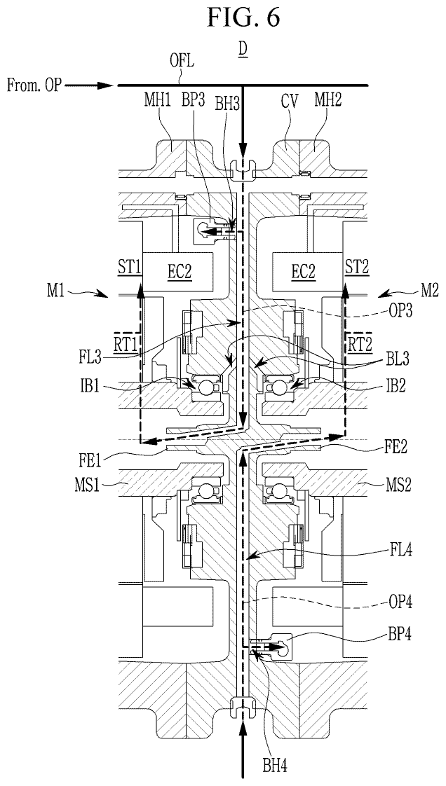

FIG. 4 is an enlarged view of the “B” portion of FIG. 3, FIG. 5 is an enlarged view of the “C” portion of FIG. 3, and FIG. 6 is an enlarged view of the “D” portion of FIG. 3.

Referring to FIG. 1, FIG. 3, and FIG. 4, the first motor housing MH1 accommodates the first motor M1 including the first stator ST1 and the first rotor RT1 therein, and a first oil path OP1 is formed to supply cooling oil provided from an oil pump OP to the outer end coil portion EC1 and an outer bearing part OB1 of the first motor M1.

The first stator ST1 is fixed to the inner surface of the first motor housing MH1, the first rotor RT1 is installed on the outer side of the first motor shaft MS1, and the first outer bearing part OB1 supporting rotation of the first motor shaft MS1 is mounted on the first motor housing MH1.

The first motor shaft MS1 is fitted into the ball bearing of the first outer bearing part OB1 installed at the center of the outer surface of the first motor housing MH1, and configured to rotatably support the first motor shaft MS1, and lubrication and cooling of the first outer bearing part OB1 are required.

The first oil path OP1 may include a first supply passage FL1, a first branch flow channel BL1, and a first branch pipe BP1.

The first supply passage FL1 is formed in a radial direction inside the outer surface from one side of the first motor housing MH1 to the first outer bearing part OB1 so as to supply cooling oil.

The first branch flow channel BL1 is formed as a flow channel branched from the first supply passage FL1 toward the outer surface of the first rotor RT1, the first branch pipe BP1 is fitted and installed on the first branch flow channel BL1, and is configured to guide and inject cooling oil to the outer end coil portion EC1 of the first motor M1.

Referring to FIG. 1, FIG. 3, and FIG. 5, the second motor housing MH2 may be arranged in parallel adjacent to the first motor housing MH1 and accommodates the second motor M2 including the second stator ST2 and the second rotor RT2 therein. In addition, a second oil path OP2 is formed to supply cooling oil supplied from the oil pump OP to the outer end coil portion EC1 and the outer bearing part OB2 of the second motor M2.

The second stator ST2 is fixed to the inner surface of the second motor housing MH2, the second rotor RT2 is installed on the outer side of the second motor shaft MS2, and the second outer bearing part OB2 for rotatably supporting the second motor shaft MS2 is mounted in the second motor housing MH2.

The second outer bearing part OB2 is configured to have the second motor shaft MS2 fitted into the ball bearing of the second outer bearing part OB2 installed at the center of the outer surface of the second motor housing MH2 to rotatably support the second motor shaft MS2, and lubrication and cooling of the second outer bearing part OB2 may be required.

The second oil path OP2 may include a second supply flow path FL2, a second branch flow path BL2, and a second branch pipe BP2.

The second supply flow path FL2 is formed in the radial direction inside the outer surface from one side of the second motor housing MH2 to the second outer bearing part OB2, so as to supply cooling oil.

The second branch flow path BL2 is formed as a flow path branched from the second supply flow path FL2 toward the outer surface of the second rotor RT2, and the second branch pipe BP2 is fitted and installed on the second branch flow path BL2, and is configured to guide and inject cooling oil to the outer end coil portion EC1 of the second motor M2.

Referring to FIG. 2, FIG. 3, and FIG. 6, the motor cover CV is disposed between the first motor housing MH1 and the second motor housing MH2 to partition each space and to protect the interior region of each of the first motor M1 and the second motor M2, and is fastened together with the first and second motor housings (MH1 and MH2).

The first and second inner bearing parts IB1 and IB2 are respectively mounted between both side surfaces of the motor cover CV and each inner end of the first and second motor shafts MS1 and MS2 so as to rotatably support each inner end of the first and second motor shafts MS1 and MS2.

The motor cover CV is formed with a third oil path OP3 configured to supply cooling oil from one side to the inner end coil portion EC2, the first stator ST1, and the first rotor RT1 of the first motor M1, and the inner bearing parts IB1 and IB2. In addition, a fourth oil path OP4 is formed in the motor cover CV so as to supply cooling oil from the other side to the inner end coil portion EC2, the second stator ST2, and the second rotor RT2 of the second motor M2.

The motor cover CV includes a first supply end FE1 and a second supply end FE2, each formed by being extended in the axial direction on both central sides so as to supply cooling oil toward the inside of the hollow first motor shaft MS1 and the hollow second motor shaft MS2, respectively. The first and second supply ends FE1 and FE2 may be formed toward the inner sides of the first and second motor shafts MS1 and MS2.

The first and second inner bearing parts IB1 and IB2 are configured such that respective inner ends of the first and second motor shafts MS1 and MS2 are fitted into ball bearings respectively installed on both sides of the motor cover CV, thereby rotatably supporting the first and second motor shafts MS1 and MS2, and requiring lubrication and cooling. The third oil path OP3 may include a third supply passage FL3, a third branch hole BH3, a third branch pipe BP3, and a third branch passage BL3.

The third supply passage FL3 is formed in a radial direction inside the motor cover CV from one side thereof to the first supply end FE1, so as to supply cooling oil into the hollow inside of the first motor shaft MS1.

The third branch hole BH3 is formed to branch from one side of the third supply passage FL3 toward the inner surface of the first stator ST1, and the third branch pipe BP3 is fitted and installed onto the third branch hole BH3, and is configured to guide and inject cooling oil into the inner end coil portion EC2 of the first motor M1.

The third branch flow channel BL3 is formed by branching to both sides from the third supply passage FL3 toward the first and second inner bearing parts IB1and IB2, and is configured to guide and supply cooling oil to the first and second inner bearing parts IB1 and IB2.

The fourth oil path OP4 may include a fourth supply passage FL4, a fourth branch hole BH4, and a fourth branch pipe BP4.

The fourth supply passage FL4 is formed inside the motor cover CV in the radial direction from the other side of the motor cover CV to the second supply end FE2, and is configured to supply cooling oil into the hollow inside of the second motor shaft MS2.

The fourth branch hole BH4 is formed to branch from one side of the fourth supply passage FL4 toward the inner surface of the second stator ST2, and the fourth branch pipe BP4 is fitted onto the fourth branch hole BH4 and installed, and is configured to guide and inject cooling oil to the inner end coil portion EC2 of the second motor M2.

The cooling oil supplied to the interiors of the first and second motor shafts (MS1 and MS2) through the third and fourth oil paths (OP3 and OP4) may be scattered, due to the centrifugal force generated by the rotation of the first and second motor shafts (MS1 and MS2), to the first and second stators (ST1 and ST2) and the first and second rotors RT1 and RT2 through oil holes or the like formed in the inner walls of the first and second motor shafts MS1 and MS2, thereby cooling the coil.

Referring to FIG. 1 and FIG. 3, the oil pump OP is connected to the first, second, third, and fourth oil paths OP1, OP2, OP3, and OP4 and the oil supply line OFL, and may include an electronic oil pump that pumps oil inside the oil chamber OC to each oil path OP1, OP2, OP3, and OP4 according to an electric signal.

In other words, the oil pump OP may be provided outside the first and second motor housings MH1 and MH2, and may be driven by an electric motor operated with power from a battery.

In an embodiment of the present disclosure, a single oil pump OP may supply cooling oil to each of a first, second, third, and fourth oil paths OP1, OP2, OP3, and OP4 which are provided to cool the first motor M1 and the second motor M2, but, if necessary, an auxiliary pump may be additionally applied.

As described above, the twin motor system for an electric vehicle according to the embodiments of the present disclosure may accommodate the twin motor in which the first and second motors M1 and M2 are arranged in parallel inside the first and second motor housings MH1 and MH2, and may compactly configure the drive mechanism by partitioning the installation space of the first and second motors M1 and M2 so that the single motor cover CV is shared.

In addition, the cooling oil supplied from the oil pump OP may be directly supplied to the heat-generating part of the first motor M1 and the second motor M2 through the four oil paths OP1, OP2, OP3, and OP4 formed inside the first motor housing MH1, the second motor housing MH2, and the motor cover CV, thereby enhancing cooling performance.

Hereinafter, the supply process of cooling oil through four oil paths OP1, OP2, OP3, and OP4 is described in detail.

With reference to FIG. 3 and FIG. 4, when the oil pump OP is operated according to an electrical signal, oil inside the oil chamber OC is pumped and cooling oil is supplied to the first oil path OP1 through the oil supply line OFL.

The cooling oil supplied to the first supply passage FL1 of the first oil path OP1 is partially injected directly into the outer end coil portion EC1 of the first motor M1 through the first branch pipe BP1 on the first branch flow channel BL1, thereby cooling the outer end coil portion EC1, and the remainder is directly supplied to the first outer bearing part OB1, thereby cooling the first outer bearing part OB1.

Referring to FIG. 3 and FIG. 5, the oil pump OP supplies cooling oil to the second oil path OP2 through the oil supply line OFL.

The cooling oil supplied to the second supply flow path FL2 of the second oil path OP2 is partially injected directly into the outer end coil portion EC1 of the second motor M2 through the second branch pipe BP2 on the second branch flow path BL2, thereby cooling the outer end coil portion EC1, and the remainder is directly supplied to the second outer bearing part OB2 to cool the second outer bearing part OB2.

Referring to FIG. 3 and FIG. 6, the oil pump OP supplies cooling oil to the third and fourth oil paths OP3 and OP4 through the oil supply line OFL.

The cooling oil supplied to the third supply passage FL3 of the third oil path OP3 is partially injected directly into the inner end coil portion EC2 of the first motor M1 through the third branch pipe BP3 on the third branch hole BH3, thereby cooling the inner end coil portion EC2, and partially supplied directly to the first and second inner bearing parts IB1 and IB2 through the third branch passage BL3, thereby cooling the first and second inner bearing parts IB1 and IB2. In addition, the remainder is supplied into the hollow of the first motor shaft MS1, and by the centrifugal force generated by the rotation of the first motor shaft MS1, it is scattered to the first stator ST1 and the first rotor RT1 through oil holes formed on the inner wall of the first motor shaft MS1, thereby cooling the coil.

The cooling oil supplied to the fourth supply passage FL4 of the fourth oil path OP4 is partially injected directly through the fourth branch pipe BP4 on the fourth branch hole BH4 to the inner end coil portion EC2 of the second motor M2 to cool the inner end coil portion EC2, and the remainder is supplied into the hollow of the second motor shaft MS2, where, by the centrifugal force generated by the rotation of the second motor shaft MS2, it is scattered through the oil hole formed on the inner wall of the second motor shaft MS2 or the like to the second stator ST2 and the second rotor RT2, thereby cooling the coil.

While the foregoing has been described with reference to some embodiments of the present disclosure, it should be understood by those having ordinary skill in the art that various modifications and changes may be made in the present disclosure without departing from the spirit and scope of the present disclosure as set forth in the following claims.

### DESCRIPTION OF SYMBOLS

M1, M2: first, second motor
MS1, MS2: first, second motor shaft
OP: hydraulic pump
OP1, OP2, OP3, OP4: first, second, third, fourth oil path
RD1, RD2: first, second reducer
ST1, ST2: first, second stator
RT1, RT2: first, second rotor
EC1: outer end coil portion
EC2: inner end coil portion
MH1, MH2: first, second motor housing
CV: motor cover
OB1, OB2: first, second outer bearing part
IB1, IB2: first, second inner bearing part
FL1, FL2, FL3, FL4: first, second, third, fourth supply passage
BL1, BL2, BL3, BL4: first, second, third, fourth branch flow channel
BP1, BP2, BP3, BP4: first, second, third, fourth branch pipe
BH3: third branch hole
FE1, FE2: first, second supply end

What is claimed is:

1. A twin motor system for an electric vehicle, the twin motor system comprising:
a first motor housing accommodating a first motor having a first stator and a first rotor therein, wherein a first oil path is formed in the first motor housing to supply cooling oil, which is supplied from an oil pump, to an outer end coil portion and a bearing part of the first motor;
a second motor housing disposed in parallel adjacent to the first motor housing, accommodating a second motor having a second stator and a second rotor therein, wherein a second oil path is formed in the second motor housing to supply the cooling oil to an outer end coil portion and a second outer bearing part of the second motor;
a motor cover including a third oil path and a fourth oil path and disposed between the first motor housing and the second motor housing to protect each of the first motor and the second motor,
wherein the third oil path is configured to supply the cooling oil, from a first side, to an inner end coil portion, the first stator, the first rotor, and a first inner bearing part of the first motor and a second inner bearing part of the second motor, and the fourth oil path is configured to supply the cooling oil, from a second side, to an inner end coil portion, the second stator, and the second rotor of the second motor; and
a first reducer and a second reducer respectively disposed on outer sides of the first motor housing and the second motor housing.

2. The twin motor system of claim 1, further comprising a first outer bearing part mounted to the first motor housing and configured to rotatably support an outer end of a first motor shaft on which the first rotor is installed.

3. The twin motor system of claim 2, wherein the first oil path comprises:
a first supply passage formed in a radial direction inside an outer surface from one side of the first motor housing to the first outer bearing part, and configured to supply cooling oil;
a first branch flow channel branching from the first supply passage toward an outer surface of the first rotor; and
a first branch pipe installed on the first branch flow channel and configured to guide the cooling oil to the outer end coil portion of the first motor.

4. The twin motor system of claim 1, further comprising a second outer bearing part mounted to the second motor housing and configured to rotatably support an outer end portion of a second motor shaft on which the second rotor is installed.

5. The twin motor system of claim 4, wherein the second oil path comprises:
a second supply flow path formed in a radial direction inside an outer surface from one side of the second motor housing to the second outer bearing part and configured to supply cooling oil;
a second branch flow path branched from the second supply flow path toward an outer surface of the second rotor; and
a second branch pipe provided on the second branch flow path and configured to induce the cooling oil to the outer end coil portion of the second motor.

6. The twin motor system of claim 1, wherein the motor cover comprises first and second supply ends formed axially on opposite central sides thereof, and configured to supply the cooling oil toward an interior of a first motor shaft of the first motor and an interior of a second motor shaft of the second motor.

7. The twin motor system of claim 1, further comprising first and second inner bearing parts configured to rotatably support an inner end of a first motor shaft of the first motor and an inner end of a second motor shaft of the second motor, respectively,
wherein the first and second inner bearing parts are respectively mounted between sides of the motor cover and the inner ends of the first and second motor shafts.

8. The twin motor system of claim 7, wherein the third oil path comprises:
a third supply passage formed radially inside from a first side of the motor cover to a first supply end of the motor cover to supply the cooling oil;
a third branch hole branched from the third supply passage toward an inner surface of the first stator;
a third branch pipe installed on the third branch hole to guide the cooling oil to the inner end coil portion of the first motor; and
a third branch passage branched from the third supply passage to both sides toward the first and second inner bearing parts.

9. The twin motor system of claim 8, wherein the fourth oil path comprises:
a fourth supply passage formed radially inside from a second side of the motor cover to a second supply end of the motor cover to supply the cooling oil;
a fourth branch hole branched from the fourth supply passage toward an inner side surface of the second stator; and
a fourth branch pipe installed on the fourth branch hole to guide the cooling oil to the inner end coil portion of the second motor.

10. The twin motor system of claim 1, wherein the oil pump is an electronic oil pump connected through the first, second, third, and fourth oil paths and an oil supply line.

11. A twin motor system for an electric vehicle, the twin motor system comprising:
a first motor housing accommodating a first motor having a first stator and a first rotor therein, wherein a first oil path is formed in the first motor housing to supply cooling oil to an outer end coil portion and a bearing part of the first motor;
a second motor housing accommodating a second motor having a second stator and a second rotor therein, wherein a second oil path is formed in the second motor housing to supply the cooling oil to an outer end coil portion and a second outer bearing part of the second motor;
a motor cover including a third oil path and a fourth oil path and disposed between the first motor housing and the second motor housing,
wherein the third oil path is configured to supply the cooling oil to an inner end coil portion, the first stator, the first rotor, and a first inner bearing part of the first motor and a second inner bearing part of the second motor, and the fourth oil path is configured to supply the cooling oil to an inner end coil portion, the second stator, and the second rotor of the second motor; and
a first reducer and a second reducer respectively disposed on outer sides of the first motor housing and the second motor housing.

12. The twin motor system of claim 11, further comprising a first outer bearing part mounted to the first motor housing and configured to rotatably support an outer end of a first motor shaft on which the first rotor is installed.

13. The twin motor system of claim 12, further comprising a second outer bearing part mounted to the second motor housing and configured to rotatably support an outer end portion of a second motor shaft on which the second rotor is installed.

14. The twin motor system of claim 13, wherein the first oil path comprises:
a first supply passage formed in a radial direction inside an outer surface from one side of the first motor housing to the first outer bearing part, and configured to supply cooling oil;
a first branch flow channel branching from the first supply passage toward an outer surface of the first rotor; and
a first branch pipe installed on the first branch flow channel and configured to guide the cooling oil to the outer end coil portion of the first motor.

15. The twin motor system of claim 13, wherein the second oil path comprises:
a second supply flow path formed in a radial direction inside an outer surface from one side of the second motor housing to the second outer bearing part and configured to supply cooling oil;
a second branch flow path branched from the second supply flow path toward an outer surface of the second rotor; and
a second branch pipe provided on the second branch flow path and configured to induce the cooling oil to the outer end coil portion of the second motor.

16. The twin motor system of claim 13, wherein the motor cover comprises first and second supply ends extended axially on opposite central sides thereof, and configured to supply the cooling oil toward an interior of the first motor shaft and an interior of the second motor shaft.

17. The twin motor system of claim 16, wherein the first and second inner bearing parts are respectively mounted between sides of the motor cover and inner ends of the first and second motor shafts.
